(19) United States
(12) Patent Application Publication
(10) Pub. No.: US 2002/0048138 A1
(43) Pub. Date: Apr. 25, 2002

(54) DISENGAGEABLE ELECTRICAL CAPACITIVE COUPLING SYSTEM TO PROVIDE ENHANCED CONDUCTIVITY

(76) Inventors: Jeffrey A. Rose, Park City, UT (US); Joseph A. Cates, Bowling Green, KY (US)

Correspondence Address: KING & SCHICKLI, PLLC, 247 NORTH BROADWAY, LEXINGTON, KY, 40507, US

(21) Appl. No.: 09/782,398

(22) Filed: Feb. 13, 2001

Related U.S. Application Data
(60) Provisional application No. 60/183,284, filed on Feb. 17, 2000.

(51) Int. Cl. H01G 4/35

(52) U.S. Cl. 361/302

(57) ABSTRACT

A disengageable electrical capacitive coupling system with enhanced conductivity of the coupling is provided. The coupling is designed for transmitting high frequency AC electrical current and includes dual connectors on the vehicle side mating with dual couplers on the charger side. The system includes a selection of applicators for applying liquid cleaner materials to the plates of the dual connectors/couplers to loosen and remove substantially all foreign particles, as well as air pockets. The applicators include porous rollers, a combination spray nozzle and squeegee, a direct applicator through the foam forming the coupler plates and a scraper to provide additional beneficial treatment to the plate surface. The cleaner materials can be water or a conductive liquid solution, including an additive of a strong electrolyte, to further enhance the coupling function.

### RELATED APPLICATION

Applicant claims priority for this utility patent application based on the corresponding Provisional Application No. 60/183,284, filed Feb. 17, 2000.

### BACKGROUND

The present invention relates to couplings for high frequency AC electrical current systems, and more particularly to a coupling system, especially in a charging system, providing improvements in the conductivity between the conductive or dielectric coupler, such as on the charger side, and the dielectric connector, such as on the battery side.

This is an improvement with respect to the invention disclosed and claimed in U.S. Pat. No. 5,714,864, issued Feb. 3, 1998, and is incorporated herein by reference.

The charging system of the '864 patent has provided the technology breakthrough for efficient and low cost electric vehicle battery charging. The use of such chargers will increase substantially over the next few decades due to the switch to electric motors from internal combustion engines. The capacitive charger is not only more efficient and less costly than conductive and inductive chargers, it provides a coupling that is inherently safe to the user. As set forth in the '864 patent, the capacitive charge coupling is an important link in making the electric vehicle acceptable to the public.

The only known concern that has been raised since the invention of the basic capacitive coupling of the '864 patent is the potential for foreign particles, such as dust and/or air bubbles to be introduced into the interface between the plates. In a capacitive coupling, while the efficiency of transmission and the superior reliability is clearly demonstratable in a laboratory setting, if the connector/coupler plates are separated by a foreign dielectric substance then the efficiency of transmission suffers.

We have discovered that to provide a truly efficient capacitive coupling system useable in the real world application, such as for a vehicle, a provision must be made for cleaning the plates prior to the coupler being engaged.

Accordingly, the need identified beyond the invention of the basic coupling relates to providing a coupler system that substantially eliminates the trapping of foreign particles or air bubbles that can lower the efficiency of the capacitive transfer of current between the plates. The addition of cleaning material must be done in such a way that the capacitive coupling system remains low in initial cost, as well as being safe. The system also should inherently increase the efficiency of the coupling by leaving a conductive liquid film between the plates, and be characterized by low maintenance requirements and no bad side effects.

### SUMMARY OF THE INVENTION

Accordingly, an important aspect of the present invention is to provide a system for capacitive coupling that includes an applicator for liquid cleaner materials for the purpose of enhancing the performance of the coupler. The cleaner materials are designed to loosen and remove substantially all foreign particles, including dust, as well as air pockets that some times tend to form. By removing these sources of dielectric separation between the plates, the capacitive charge coupling is made substantially more efficient.

Further in accordance with the present invention, the cleaner material is preferably an aqueous base conductive liquid, such as water (H₂O). To improve the conductivity even further, the present invention contemplates providing an additive in the form of a strong electrolyte. The selection of the electrolyte is made so as to be non-toxic and non-corrosive and may include sodium chloride (NaCl), sodium hydroxide (NaOH) and/or hydrogen chloride (HCl). Other suitable selections include metallic salts and solid polymer salt electrolytes.

The coupler of the coupling assembly is mounted for movement along a path for engaging its dual coupler plates with the cleaning mechanism. This mechanism can take several forms, and one of those selected for purposes of explaining the invention is a porous roller applicator for each plate. As the plates move past the roller applicator, which is fixed in position, the solution held within a foam rubber covering is applied. The rollers are fed with cleaning material through an internal perforated pipe that allows the liquid to flow through the foam rubber cover for even distribution across the corresponding plate surface. Any fine particles attached to the plates, such as dust, are loosened and removed by the cleaning material. Inherently a thin film of the liquid material stays on the plate to eliminate any minute air pockets and thus allow the plates to be fully mated when squeezed together. In some instances, a back and forth movement of the coupler helps to fully clean and coat the plates with the liquid.

In some instances, it is desirable to remove any excess liquid cleaning material by employing a stationary perforated vacuum manifold next to the plate. The manifold sucks excess liquid away from the plate but leaves a wetting film behind. The plate stands by clean in readiness for the coupling operation. A suction tube can also be provided to remove excess liquid squeezed from the roller during the initial application.

Selection of a different applicator can be made within the broad principles of the present invention. One such applicator is a spray nozzle to direct the solution against the coupler plate in combination with a different remover device, such as a bidirectional squeegee. The liquid is distributed evenly, as well as the excess liquid being removed by the squeegee.

The efficiency of the coupling system is further enhanced by use of foil cables that are highly efficient in transmitting the high frequency, high voltage charge. The foil cables are used both on the input and the output side of the coupling.

In order to minimize the amount of dust, or other foreign particles being deposited on the plates, the connector on the electric vehicle side fits within a recess, which is closed at all times except during charging by retractable doors. Also, the coupler plates on the charger side are protected by a pivotal flap that lifts when the coupling is being engaged.

In still another embodiment, a conductive liquid solution for cleaning and elimination of air bubbles feeds directly to the foam base of the coupler plates. The liquid permeates the foam to a saturation allowing the liquid to be evenly distributed across its face to perform its cleaning and conductivity functions. If desired, a thin metal foil with spaced pin hole perforations can be placed on the foam to further enhance the conductivity of the surface. In still another approach, rollers can be used on a manually inserted paddle to clean and provide the conductive layer of liquid to the coupler plates.

A secondary or alternative treatment of the connector plates, as contemplated by the present invention, is through scraping action. Scrapers that move across the connector plates on the vehicle side are illustrated. These cooperate with separate sprayers for the liquid cleaning material. A suitable scraper is made of a strip of urethane rubber, but other materials, such as polyethylene can be chosen.

Additional concepts for the applicators, the cleaning materials and other details, along with other advantages and novel aspects of the invention will be set forth in part in the description that follows, and in part will become apparent to those skilled in the art upon examination of this description, or may be learned with the practice of the invention. The different structures/materials and advantages of the invention utilizing the same may be realized and obtained by means of the instrumentalities in combinations particularly pointed out in the appended claims.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a schematic view of a preferred embodiment of the capacitive coupling system utilizing applicators for providing liquid cleaning material to the plates;

FIG. 2 is a cross sectional view taken along line 2-2 of FIG. 1 and illustrating the orientation of a roller applicator for applying the cleaning liquid to the adjacent coupler plate;

FIG. 3 is a cross sectional view taken along line 3-3, and 90° spaced from the view of FIG. 2 illustrating the roller applicator, but also adding the vacuum manifold to remove excess liquid;

FIG. 3a is a view similar to FIG. 3 illustrating an alternative arrangement where a spray nozzle applies a cleaning material which is distributed and the excess removed by an adjacent squeegee;

FIG. 4 is a view of the manner in which the connector plates are expanded (mating coupler plates not shown in this figure) in order to make the coupling;

FIG. 5 is a cross sectional view illustrating the coupler plates that are protected from foreign matter by a pivoting flap when not in use;

FIG. 6 is an enlarged detailed cross sectional view illustrating another form of the coupler plates having direct application of a conductive liquid cleaner, and the plate including a perforated metal foil for enhanced conductivity;

FIG. 7 is still another embodiment illustrating applicator rollers mounted on a paddle that is manually manipulated to clean the coupler plates; and

FIG. 8 is an overall partial schematic, similar to FIG. 1, but illustrating an additional treatment of the connector plates by a scraper mechanism.

Reference will now be made in detail to the present preferred embodiment and alternative embodiments of the invention, example of which are illustrated in the accompanying drawings.

### DETAILED DESCRIPTION OF THE PREFERRED EMBODIMENT

The capacitive coupling C, which is particularly adapted for use for interconnecting a charger to a battery in an electrical vehicle or the like, includes a mating connector 13 and coupler 14. A selection of applicator systems and liquid cleaner materials is made based on superior performance for the particular treatment of the plates. The function is to loosen and remove substantially all foreign particles from both the coupler and connector plates, including the removal of air pockets, all for better conductivity. In other words, the capacitive connection between the plates of the coupling is thus made substantially more efficient through providing cleaner plates that mate together. The cleaner material itself is also selected on the basis of excellent conductivity properties to further insure excellent performance of the coupling through the residue film left behind on the plates after cleaning.

The preferred cleaning material for the treatment of the plates is an aqueous base conductive liquid. Of course, water (H₂O) itself is conductive so that one option is to use this base liquid alone as the aqueous base conductive liquid. However, for even higher efficiency, a conductive additive as a solute in the water that acts as a solvent is used. The conductive additive is preferably a strong electrolyte. The electrolyte is non-toxic and non-corrosive, including sodium chloride (NaCl), sodium hydroxide (NaOH), and hydrogen chloride (HCl). In addition, metallic salts can be utilized, such as LiI, LiClO4, NaI, NaBr, KI, and Iron (III) chloride, hexahydrate. Solid polymer salt electrolytes are also contemplated, such as set forth in U.S. Pat. No. 4,576,882, issued Mar. 18, 1986.

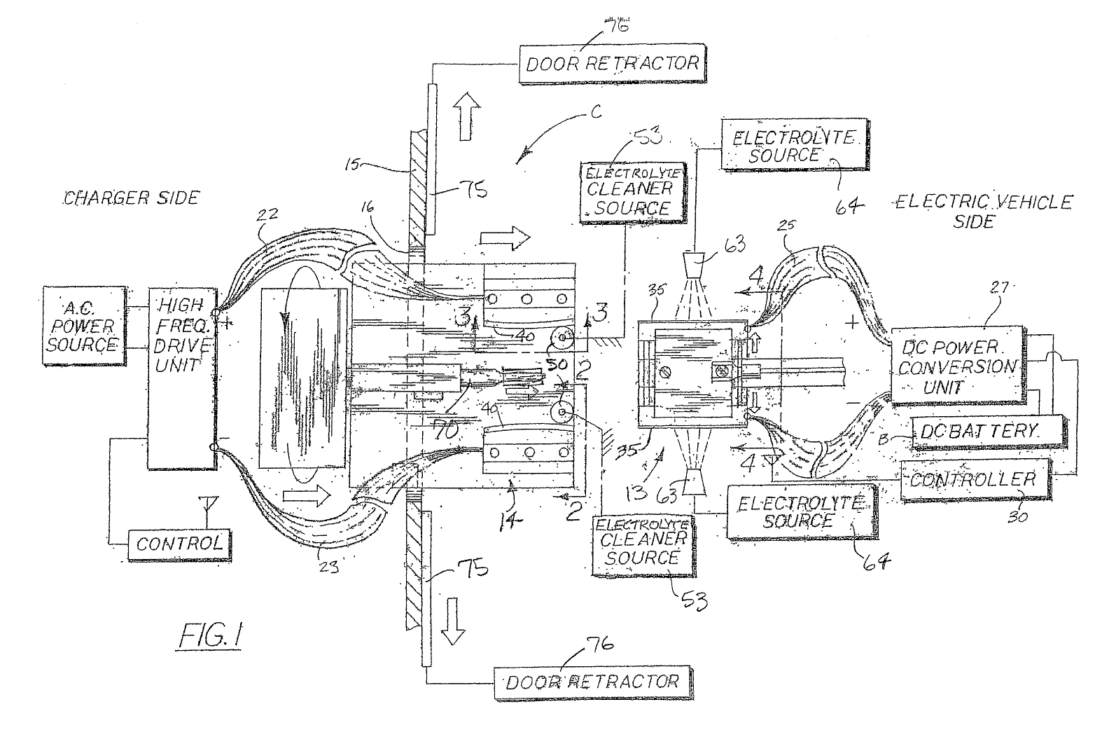

The coupler plates 40 of the coupler 14, as illustrated in FIG. 1, are mounted on a carrier for movement along a path to a position for mating with the corresponding connector plates 35 (see the '864 patent for more detail). An applicator system for cleaning the surface of each coupler plate is provided so as to engage the coupler plates 40 as the carrier is moved into position with the corresponding connector plates 35.

As in my prior U.S. '864 patent, each coupler plate 40 may comprise a conductive rubber backed by a resilient conductive foam rubber. The connector plate 35 that mates with the coupler plate 40 is preferably a high dielectric constant material, such as barium titanium oxide, a ceramic.

Alternatively, the coupler plates 40 may also be fully covered with the high dielectric constant ceramic or other dielectric covering. In this arrangement, the conductive rubber, or other flexible conductor, such as perforated metal foil, is replaced on the foam rubber backing. By properly gauging the parameters of the two ceramic coverings, including the dielectric constants and thicknesses, the same enhanced efficiency of the coupling C can be obtained. This is due to the improved conductively between the mating dielectric connector/coupler plates 35/40, since any foreign dielectric substance, such as dust or air bubbles, are loosened and removed, just as before by the applicator system of the present invention.

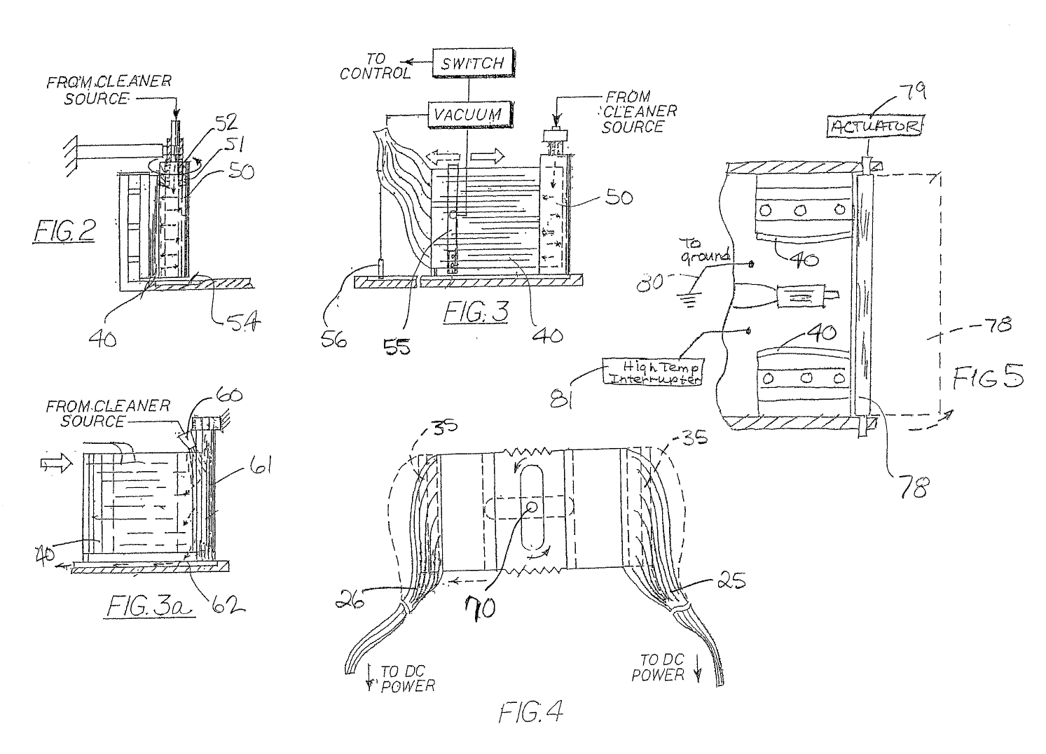

As can be seen in FIGS. 1 and 2, one form of an applicator used in the plate treatment, to thus provide the electrolyte solution to the surface of the coupler plate 40, is a porous roller applicator 50. As the plate 40 moves past the fixed positioned roller applicators (one on each side), the solution held within a foam rubber cover 51 is coated onto the plate (see full line arrow). The applicator is fed through an internal perforated pipe 52 from a cleaner source 53 and evenly distributes the liquid to the plate surface. Not only are any fine particles that are inadvertently deposited on the surface of the coupler plates loosened and removed, but the electrolyte solution leaves a thin film that is operative to improve the conductivity, including eliminating any minute air pockets, once the coupler and connector plates are squeezed together. A reservoir 54 is positioned below the applicator 50 to take any excess electrolyte solution.

With reference to FIG. 3, when the coupler plate 40 is being withdrawn from its engagement in the operative position (see dashed line arrow), the applicator 50 once again applies a fresh supply of cleaning solution. A vacuum remover, such as a stationary perforated vacuum manifold 55, can be employed to suction the excess liquid from the face of the plate during this step of the operation. A build-up of solution is thus prevented while a wetting film remains on the plate 40. Several in and out motions can be used as the coupling C is being engaged. In addition, a suction tube may be provided to remove the excess electrolyte from the reservoir (see FIG. 3). The electrolyte solution being provided to the roller applicator 50 can be controlled as to pressure and flow in order to assure the best coupling function possible.

In addition to using a roller with a foam body or cover for the applicator 50 as described above, the applicator can be a spray nozzle 60 that is directed against the coupler plate. A remover device, preferably a bidirectional squeegee 61, is utilized to distribute, as well as remove the excess liquid. In operation, as shown in FIG. 3a, the coupler plate 40 moves to the engaged and operative position as the surface is sprayed by the nozzle. The squeegee is operated to remove just the right amount of the electrolyte solution and to clean the surface. Any excess over the conductive film that is desired, runs into the reservoir 62 below and can be directed to a drain.

When the coupler plate 40 is ready to move to the retracted position outside the vehicle and away from the engaged position, the squeegee 61 removes any remaining electrolyte solution, but can leave a wetting film. In this operation, the spray nozzle 60 remains in the off condition. Advantageously, the squeegee 61 is highly effective for stripping the excess electrolyte solution, together with any suspended foreign particles from the coupler plate 40.

In addition to spraying electrolyte solution on the coupler plates 40, a provision is made for spraying a fine mist on the ceramic connector plates 35 through sprayers 63 from a secondary electrolyte source 64, as illustrated in FIG. 1.

The voltage input assembly on the charger side (see the '864 patent for details) provides the charging current through foil cables 22, 23 that are highly efficient in transmitting the high frequency, high voltage charge. Foil cables 25, 26 are also preferred for transmitting the current from the connector 13 to the output conversion unit 27 and battery B on the electric vehicle side (see FIG. 1).

A centrally located actuator rod 70 within the carrier of coupler 14 can be rotated manually by the handle in order to expand the connector plates 35 outwardly by a camming action once the full engaged position is made (see FIG. 4 and also FIG. 3 of the '864 patent). The manner of rotation of the cam is best shown in FIG. 4 wherein the ceramic connector plates 35 are moved outwardly to press against the opposed coupler plates 40 (cf. FIG. 1).

The vehicle, or other energy user may include a wall 15 in which an access port 16 is provided. This port is closed by retractable doors or shutters 75 operated by motorized retractors 76 in order to keep debris from entering the area of the connector plates 35. Similarly, the coupler 14 is protected from foreign matter by a pivotal flap 78 operated by actuator 79, which lifts and opens when the coupling C is being engaged, such as shown in FIG. 5. As the coupler 14 moves up to the access port 16, the doors 75 covering the port 16 open, and the actuator 79 lifts the flap 78 on the enclosure for the coupler 14 just before engagement, as seen in FIG. 5. As also shown in FIG. 5, a ground 80 is provided to the coupler 14 and a thermistor mounted within the coupler 14 serves as an interrupter 81 to the current flow in the event of sensing an overheating situation.

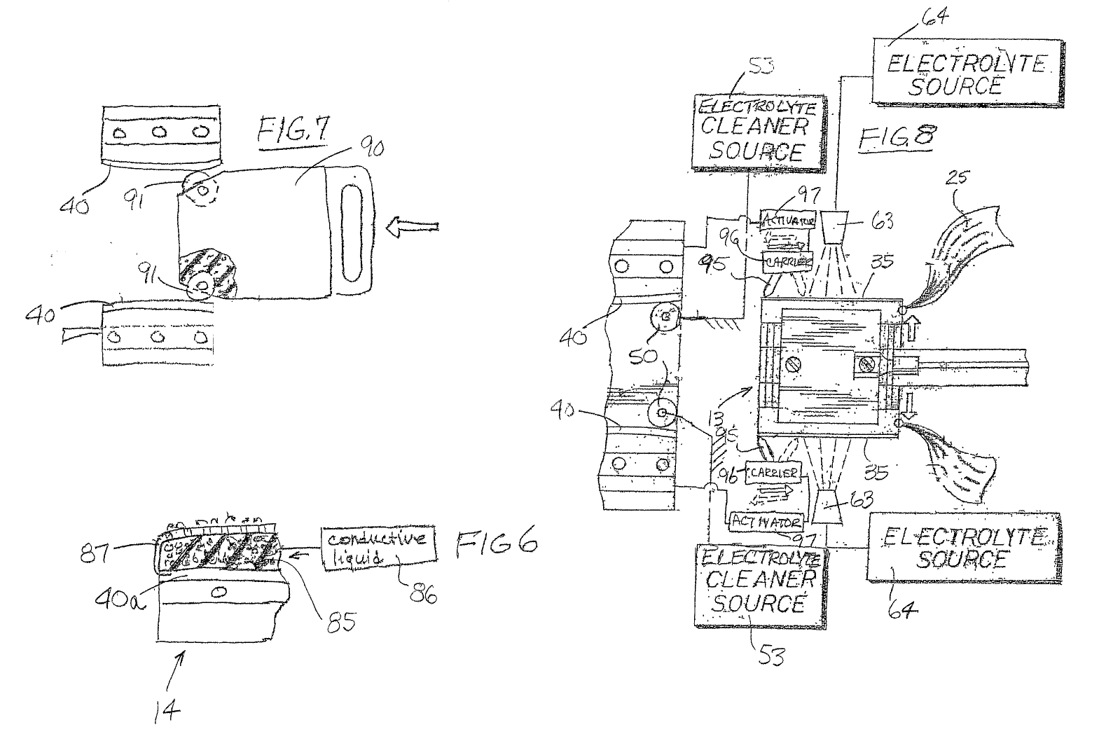

The cross sectional and cut-away view of another form of coupler plate 40a is shown in FIG. 6. This alternative approach further enhances the conductivity between the coupler and connector plates 40, 35, respectively. In this first alternative approach, the coupler plate 40a comprises a conductive foam 85 without a cover and is used so as to provide its operative surface directly with a conductive electrolyte solution. A reservoir of conductive liquid 86 feeds the solution directly to the foam, and the saturation can be controlled by pressure and/or volume flow. If desired, a multiple pin hole, perforated metal foil cover 87 may be placed over the conductive foam as the second alternative of this form. In this case the electrolyte is expressed from the perforations to form the conductive film, in the manner illustrated by the flow arrows in FIG. 6.

As also contemplated, and illustrated in FIG. 7, the cleaning and solution applying operation can be performed by a paddle 90 having a cleaning roller 91 on each side. When manually pushed into the coupler 14, the rollers engage and run over the coupler plates 40 simultaneously, to loosen and remove the debris and to provide the residual conductive film. The inside of the cartridge may include a foam body 92 that is saturated with the electrolyte so as to clean the plate surfaces as the rollers roll across them, and leave an effective, even film of the liquid over the face of the coupler plates 40.

In another alternative treatment shown in FIG. 8, the cleaning of the dielectric connector plates 35 is also effected by a scraping action. Preferably, scraper blades 95 are on a carrier 96 that is moved to sweep along the plates in response to an activator 97 upon insertion of the coupler 14 through the access port 16 (see FIG. 1). It is contemplated that a hard and durable, but nonabrasive plastic, such as high density polyethylene, is a good choice for the scrapers 95.

Each blade 95 is fabricated from relatively thin sheet stock and provided with an edge. The electrolyte is sprayed from the sprayer 63, as supplied by the source 64, just before the scraper blade 95 moves across the plate 35. This action results in more effective removal of all debris from the surface, including any minute particles. Other scrapers, such as molded, urethane rubber blades having a durometer rating in the high range, can also be used in this treatment of the plate. The powered carrier 96 supports the blades 95 and moves them back and forth (see full/dash line positions/direction arrows) just before the coupler plates 40 are brought into contact with the plates 35.

The ceramic surface of the plates 35 are honed to a high degree of smoothness and flatness to eliminate as much air gap as possible (see also the '864 patent).

In summary, this new concept to provide a cleaning solution as a part of surface treatments for the coupler plates 40, as well as the connector plates 35, provides enhanced performance over the coupling C, as originally designed and disclosed in the '864 patent. One, or both, of the connector/coupler plates 35/40 are fabricated of a high dielectric constant material, such as a ceramic. The aqueous base cleaning material, in addition to loosing and removing the foreign particles, also provides a residue film that serves to help eliminate air bubbles, and otherwise aids in forming a conductive path between the mating plates 35, 40. An electrolyte additive provides still greater conductivity. The application of the solution is advantageously adapted for a selection of different systems and components, including the roller applicator 50, the vacuum manifold 55, the nozzle and squeegee 60, 61, the cleaning cartridge 90, as well as the direct application through the foam 85 forming the plate 40a. The scraper 95 used in combination with the spray applicators 63 for the plate 35 adds still another dimension to this improvement.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. A disengageable electrical capacitive coupling system, said coupling having mating coupler and connector plates, comprising:
a cleaner source to provide cleaning material; and
an applicator for applying sufficient cleaning material to the operative face of at least one of said plates to loosen and remove substantially all foreign particles,
whereby the efficiency of the capacitive connection between said plates of the coupling is enhanced.

2. The capacitive coupling system of claim 1, wherein said cleaning material is an aqueous base conductive liquid.

3. The capacitive coupling system of claim 2, wherein said conductive liquid is a salt solution.

4. The capacitive coupling system of claim 2, wherein said coupler plate is mounted on a carrier for movement along a path to a position for mating with said connector plate, said applicator being stationarily positioned to intercept said coupler plate for cleaning prior to engagement of the plates.

5. The capacitive coupling system of claim 2, wherein is further provided a remover for excess liquid positioned along said path as the carrier is moved away from the mating position.

6. The capacitive coupling system of claim 5, wherein said remover is a vacuum manifold with openings positioned adjacent the operative surface of said coupler plate, and a vacuum source connected to the head.

7. The capacitive coupling system of claim 2, wherein said applicator is a roller with a foam body connected to said source for receiving and evenly applying said liquid.

8. The capacitive coupling system of claim 2, wherein said applicator is a spray nozzle connected to said source for evenly applying said liquid to said coupler plate and a squeegee for stripping the liquid and suspended foreign particles.

9. The capacitive coupling system of claim 8, wherein is provided a spray nozzle directed to said connector plate for spraying with conductive liquid.

10. The capacitive coupling system of claim 1, wherein is provided a pair of applicators for cleaning dual coupler plates at the same time.

11. The capacitive coupling system of claim 1, wherein said coupler connects a voltage input with a voltage output and foil cables interconnecting said input and output with said coupler and connector plates, respectively.

12. The capacitive coupling system of claim 2, wherein said conductive liquid is selected from the groups of electrolytes of sodium chloride (NaCl), sodium hydroxide (NaOH), and hydrogen chloride (HCI) and LiI, LiClO4, NaI, NaBr, KI, Iron (III) chloride hexahydrate, and solid polyethylene imine-metal salt.

13. The capacitive coupling system of claim 2, wherein said applicator is a conductive foam incorporated in said one plate, and said cleaner source is operative to continuously saturate said foam.

14. The capacitive coupling system of claim 13, wherein is provided a perforated conductive foil covering said plate.

15. The capacitive coupling system of claim 1, wherein is provided first and second enclosures for isolating the operative faces of said coupler and connector plates, a closure for each enclosure, and an actuator for each closure.

16. The capacitive coupling system of claim 2, wherein is provided a remover device for at least a portion of the conductive liquid.

17. The capacitive coupling system of claim 16, wherein said remover device comprises a squeegee.

18. The capacitive coupling system of claim 17, wherein is provided a reservoir for the conductive liquid that is removed.

19. The capacitive coupling system of claim 1, wherein is provided a ground for at least said coupler.

20. The capacitive coupling system of claim 1, wherein is provided a sensor for detecting overheating of at least said coupler.

21. A disengageable electrical capacitive coupling system, said coupling having mating coupler and connector plates, comprising:
a dielectric plate forming at least said connector; and
a scraper to clean said connector plate prior to engaging said coupler to form said capacitive coupling,
whereby the efficiency of the capacitive connection between said plates of the coupling is enhanced.

22. The capacitive coupling system of claim 21, wherein said scraper is formed of relatively thin sheet of hard plastic sharpen along its operative edge.

23. The capacitive coupling system of claim 21, wherein is provided a spray head directed to said connector plate for spraying with conductive liquid.
